(19) United States
(12) Patent Application Publication
(10) Pub. No.: US 2010/0059297 A1
(43) Pub. Date: Mar. 11, 2010

(54) TRACK SUSPENSION

(75) Inventors: Steve Urbanik, Williamson, NY (US); Keith E. Gleasman, Fairport, NY (US)

Correspondence Address: MORTON A. POLSTER;BROWN & MICHAELS, P.C., 400 M & T BANK BUILDING, 118 N. TIOGA STREET, ITHACA, NY, 14850, US

(73) Assignee: TORVEC, INC., Rochester, NY (US)

(21) Appl. No.: 12/555,945

(22) Filed: Sep. 9, 2009

Related U.S. Application Data
(60) Provisional application No. 61/095,750, filed on Sep. 10, 2008.

(51) Int. Cl. B62D 11/20

(52) U.S. Cl. 180/6.7

(57) ABSTRACT

A flexible, non-resilient strap of the tandem wheel suspension interconnects the vehicle frame and one of the rocker arms of an endless track vehicle, limiting the motion of the rocker arm in the direction of the terrain but permitting freedom of motion in an upward direction away from the terrain. The rocker arms share a support axle mounted to the vehicle frame, and each rocker arm is independently movable about the support axle. A shock-absorbing element, located in the vicinity of the strap, is preferably similarly attached between the frame and the same rocker arm to dampen the motion of the rocker arm in the direction of the terrain while permitting freedom of motion in an upward direction away from the terrain. In one embodiment, a small idler roller is positioned slightly above the endless track at a location between the two tandem wheel suspensions supporting the endless track.

### REFERENCE TO RELATED APPLICATIONS

This application claims one or more inventions which were disclosed in Provisional Application No. 61/095,750, filed Sep. 10, 2008, entitled “TRACK SUSPENSION”. The benefit under 35 USC §119(e) of the United States provisional application is hereby claimed, and the aforementioned application is hereby incorporated herein by reference.

### BACKGROUND OF THE INVENTION

1. Field of the Invention

The invention pertains to the field of suspensions for tracked vehicles. More particularly, the invention pertains to a tandem wheel arrangement used to support endless tracks for track-laying vehicles, such as tractors, tanks, and auxiliary vehicles, especially specialized vehicles used for transportation off-road as well as on conventionally paved highways for emergency and surveillance purposes.

2. Description of Related Art

A type of track-laying vehicle has been developed that can be operated over rough off-road terrain and, also, at conventional highway speeds on paved highways. The modular track-laying system used in these vehicles is disclosed in U.S. Pat. No. 6,135,220 (Gleasman et al.), which is incorporated by reference herein. Although this new track-laying system has proved very satisfactory, occasional problems have from time-to-time occurred under extreme conditions, e.g., when travelling over off-road terrain and moving over exceptionally deep obstructions.

Under these conditions, the front dual-wheel of the front tandem pair (or the rear dual-wheel of the rear tandem pair) may drop into particularly deep depressions in the terrain while the remaining portions of the track are still progressing over a generally higher level of terrain. On these occasions, this single dual-wheel drops into the depression, causing its respective rocker arm to swing through an unusually long downward arc and, simultaneously, causing the other wheel of the tandem pair to swing through an unusually long upward arc about the shared axle of the tandem pair. Although a resilient spring structure of such prior art suspensions biases the tandem pair toward the terrain and operates against conventional mechanical stops, the entire tandem mounting is still free to rotate like a rocker arm about the shared axis of the pair. When such extreme variations in terrain occur, the upward moving dual-wheel of the pair may be raised so great a distance above the interior surface of the terrain-contacting portion of the track that the guide lugs on the interior surface of the track, which are used for retaining alignment of the track with the dual-wheels of the suspension, are completely withdrawn from between the dual wheel. At such a moment, it is possible that the portion of the track that has moved out of contact with the dual-wheel may be subjected to a lateral or angular distortion by the terrain. If this occurs at a time when the dropped dual-wheel of the tandem pair suddenly strikes rising terrain, causing it to swing back in an upward arc, the withdrawn dual-wheel of the pair is driven back downward toward the terrain and back toward the interior of the track. If, under these conditions, the guide lugs of the distorted track move to the outside of the returning dual-wheel, the track becomes misaligned and may become derailed.

While this situation is relatively uncommon, the derailment of the track of an off-road vehicle is a very serious matter. There is a need in the art for a solution to this problem.

### SUMMARY OF THE INVENTION

The tandem wheel suspension for an endless track vehicle includes a pair of wheels, each wheel being independently rotatable about a separate axis mounted on a separate rocker arm. The rocker arms share a support axle mounted to the frame of the vehicle, and each rocker arm is independently movable in a vertical plane about that support axle. A strap interconnects the vehicle frame and one of the rocker arms, limiting the motion of this rocker arm in the direction of the terrain, but permitting freedom of motion in an upward direction away from the terrain. A shock-absorbing element, located in the vicinity of the strap, is preferably similarly attached between the frame and the same rocker arm to dampen the motion of this rocker arm in the direction of the terrain but also permitting freedom of motion in an upward direction away from the terrain. In one embodiment, a small idler roller is positioned slightly above the endless track at a location between the two tandem wheel suspensions supporting the endless track.

### BRIEF DESCRIPTION OF THE DRAWINGS

FIG. 1 shows a schematic partial cross-sectional side view of selected parts of a prior art modular track-laying suspension system along line 1-1 of FIG. 2.

FIG. 2 shows a schematic partial cross-sectional rear view of the prior art system of FIG. 1 along line 2-2.

FIG. 3 shows a schematic partial cross-sectional top view of the prior art system of FIG. 1.

FIG. 4A shows a schematic partial cross-sectional side view of portions of a prior art system similar to that shown in FIG. 1 with the front end encountering a deep depression in the terrain.

FIG. 4B shows a schematic partial cross-sectional end view of the prior art system of FIG. 4A along line 4B-4B.

FIG. 5A shows a schematic partial cross-sectional side view of selected portions of an endless track suspension system in an embodiment of the present invention, showing the endless track suspension standing on level ground.

FIG. 5B shows a schematic partial cross-sectional end view of the system of FIG. 5A along line 5B-5B.

FIG. 6A shows a schematic partial cross-sectional side view of selected portions of an endless track suspension system in an embodiment of the present invention including a minor top roller variation and showing the endless track suspension encountering rising terrain.

FIG. 6B shows a schematic partial cross-sectional end view of the system of FIG. 6A along line 6B-6B.

FIG. 7A shows a schematic partial cross-sectional side view of selected portions of the endless track suspension of FIG. 5A encountering a deep depression in the terrain.

FIG. 7B shows a schematic partial cross-sectional end view of the system of FIG. 7A along line 7B-7B.

FIG. 8 shows a slightly enlarged schematic partial cross-sectional end view of an endless track suspension system including a shock-absorbing element in an embodiment of the present invention.

### DETAILED DESCRIPTION OF THE INVENTION

The present invention improves the design of the tandem wheels used to support the endless tracks of track-laying vehicles. While this description primarily refers to the tandem wheel pair used to support the front end of a flexible endless track, it should be understood that the same structure may be used, in mirror image, to improve a tandem wheel pair supporting the rear end of a flexible endless track.

The term “flexible” as used herein refers to the property of being capable of bending without breaking.

The term “non-resilient” as used herein refers to the property of being non-elastic, i.e. not elastically stretching when pulled.

A strap, preferably flexible but non-resilient, is fixed to the rocker arm of the front dual-wheel of the tandem pair. The other end of the strap is anchored to the vehicle frame. The length of the strap is adjusted so that when the strap is fully extended and the vehicle is standing on a level surface, the front dual wheel mounted on the rocker arm is in snug contact with the terrain. Such a flexible but non-resilient strap may be made from any well known woven natural, man-made, or metal fabric that has a breaking-strength sufficient to sustain the loads to which the carrier arm may be subjected. For instance, a commercially-available 2″ (5 cm)-wide woven nylon strap may be used. Also, the structure anchoring the strap to the frame may permit adjustment of the fully-extended length of the strap.

While this arrangement limits the travel of the rocker arm in a downward arc about the shared axis of the tandem pair, it permits the same rocker arm complete freedom to move in an upward arc.

Thus, should the front end of the endless track pass over a deep trench, e.g., at least 18″ (45 cm), while the rear dual-wheel of the front tandem pair is still being supported by terrain, the front dual-wheel does not drop into the trench but rather is retained by the strap in general alignment with the terrain under the rear dual wheel of the front tandem pair. In this manner, if the width of the deep trench is less than a predetermined distance, such as, for example, 18-24″ (45-60 cm), the track carries the vehicle across the trench with relatively little change in vertical movement. Further, and more importantly, the prevention of the downward drop of the front dual-wheel concomitantly prevents the above-described simultaneous upward movement of the rear dual-wheel above the interior surface of the guide lugs of the track and, thus, the possible derailment of the track when its front end contacts the other side of the trench.

On the other hand, should the front end of the endless track pass over a high obstruction, such as, for example 18-24″ (45-60 cm) high or more, the front dual-wheel remains free to move in an upward arc without restraint, allowing the track to lift the vehicle over the obstruction.

The present invention preferably also utilizes a shock-absorbing element that is positioned in the vicinity of the strap between the frame and the same rocker arm to dampen the movement of the front dual-wheel but, again, only in the downward direction. This shock-absorbing element is preferably used only on the tandem wheel pair used to support the front end of a flexible endless track.

The present invention preferably also includes an additional feature for those suspensions that have one pair of tandem wheels supporting the front end of the endless track and a second pair of tandem wheels supporting the rear end of the endless track. At least one small idler roller is connected to the vehicle frame and positioned slightly higher than the highest elevation of the endless track when the vehicle is standing on level ground. This roller is positioned to contact the entire width of the exterior surface of the track at a location between the rearward wheel of the tandem pair at the front end of the endless track and the forward wheel of the tandem pair at the rear end of the endless track.

The idler roller provides an additional structure directed to the minimization of a potential separation between the guide lugs on the interior surface of the track and the dual-wheels supporting the track. For instance, the added roller restricts undesirable upward movement of the rear tandem wheel, maintaining the wheel in substantial alignment with the guide lugs. The addition of this roller avoids the prior art problem caused when the extreme dropping of the front tandem wheel causes the concomitant extreme rising of the rear tandem wheel. This provides further assurance against unwanted derailment of the track.

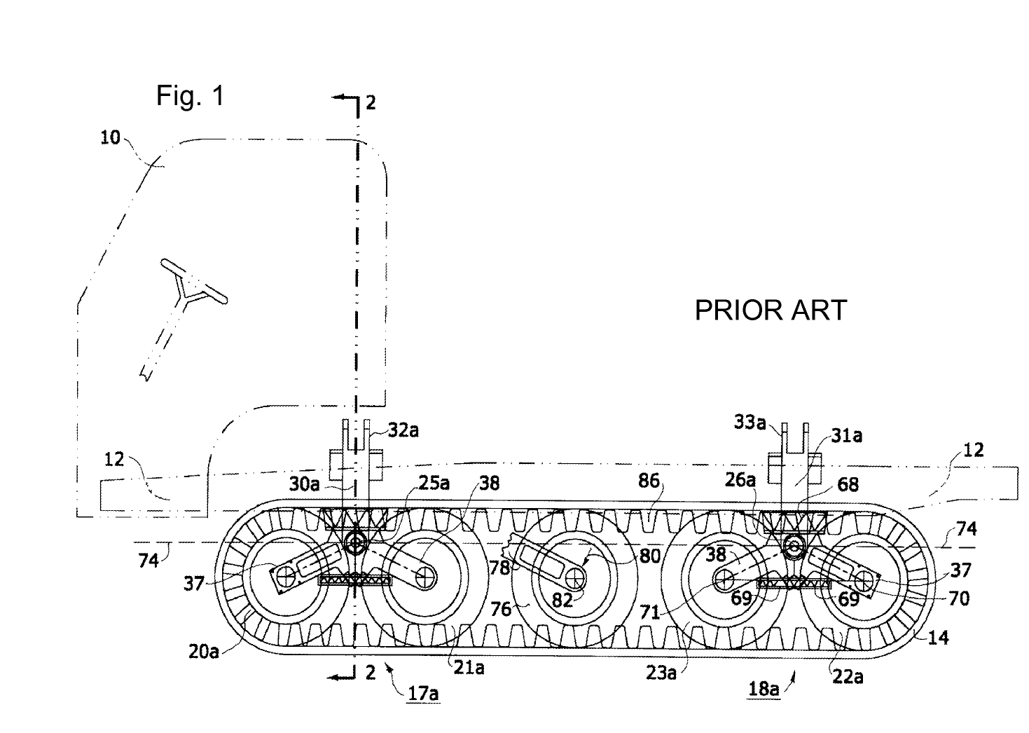

Since the present invention has particular pertinence to the tandem dual-wheel arrangements used by the track suspensions of the type generally disclosed in the above-identified Gleasman patent (U.S. Pat. No. 6,135,220), this prior art apparatus will first be described in some detail with reference to FIGS. 1, 2, and 3 that are, respectively, side, rear, and top views of selected parts of the system with some parts omitted to enhance clarity. The suspension system in these figures is shown as applied to an existing truck, which is depicted with phantom lines.

In these figures, the prior art modular suspension system is shown mounted as the undercarriage of a conventional vehicle (e.g., a truck without a truck body). The vehicle's passenger cabin 10 and load-bearing frame 12 are shown in phantom lines to distinguish the pre-existing vehicle to which the modular track suspension has been affixed.

The modular suspension system preferably includes a pair of endless rubber tracks suspended beneath the load-bearing frame 12 on opposite sides of the vehicle, namely, the left-side track 14 and the right-side track 15. The left-side track 14 and right-side track 15 and their supporting drive structures are preferably mirror images of each other. Each track 14, 15 is preferably driven by a respective pair of drive units 17a, 18a and 17b, 18b that are in frictional driving contact with the front and rear ends of each endless track 14, 15. Each drive unit 17a, 17b, 18a, 18b has a respective pair of dual-wheels 20a, 21a; 20b, 21b; 22a, 23a; 22b, 23b, respectively, arranged in tandem.

A respective drive-unit axle 25a, 25b, 26a, 26b is associated with each drive unit 17a, 17b, 18a, 18b and is positioned intermediate between the wheels 20a, 21a; 20b, 21b; 22a, 23a; 22b, 23b, respectively. Also, respective dual sprockets 28a, 28b, 29a, 29b are associated with each drive unit 17a, 17b, 18a, 18b, respectively, being fixed by splines to rotate with each drive-unit axle 25a, 25b, 26a, 26b, respectively.

The outer end of each drive-unit axle 25a, 25b, 26a, 26b is journaled in an extension 30a, 30b, 31a, 31b of a cantilever-type strut 32a, 32b, 33a, 33b, respectively, which is attached to the vehicle frame 12, while the inner end of each axle 25a, 25b, 26a, 26b is journaled in a respective right-angle box 34a, 34b, 35a, 35b that also serves as a structural element of the torque delivery system.

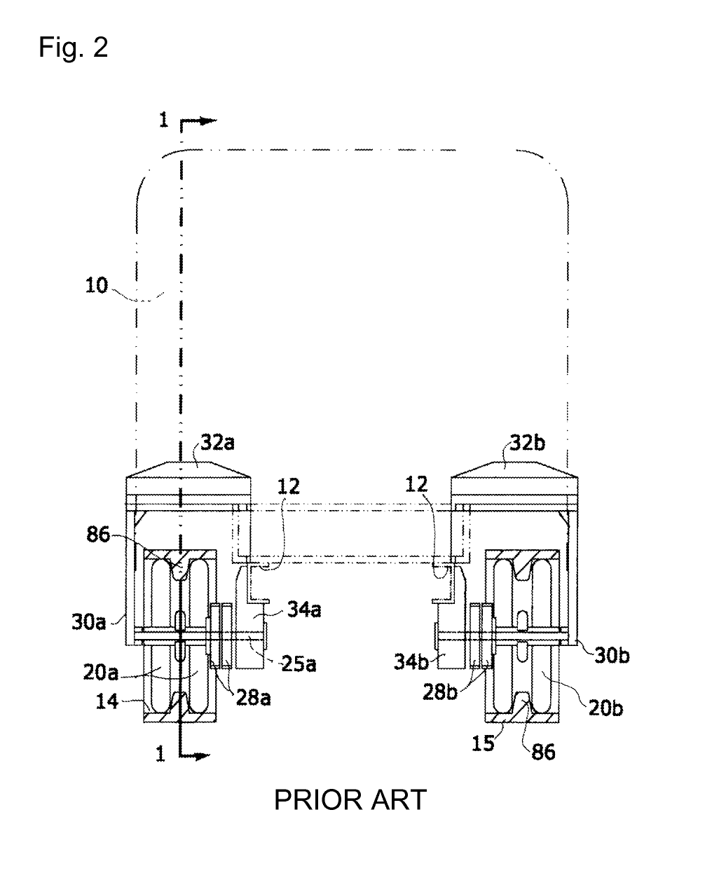

The drive units 17a, 17b, 18a, 18b are functionally identical and only one or two of the drive units are described further described in detail. As can be seen best in FIGS. 1 and 2, the dual-wheels 20a, 22a; 21a, 23a are supported by the outer ends of the respective rocker arms 37, 38, each of which is independently rotatable about the axis of the axle 25a, 26a.

Since articulation of the tandem dual-wheels of each drive unit 17a, 17b, 18a, 18b is functionally identical, the following description makes reference to only the rear drive unit 18a as illustrated in FIG. 1. Sets of springs 68 and 69 act, respectively, against mating sets of upper and lower flanges (not shown in detail) formed above and below the inner ends of the rocker arms 37 and 38, biasing the rocker arms and their respective dual-wheels downwardly in the direction of the terrain. In the position illustrated, each rocker arm is shown extended downward to its lower limit, i.e., against conventional stops (not shown).

Each rocker arm 37, 38 is independently rotatable about the axis of the drive-unit axle 26a in a vertical plane perpendicular to that axis. When traversing an uneven surface of unpaved terrain, each dual-wheel 22a, 23a may move upward against the downward spring bias to a maximum upward position where the centerline 70, 71 of its respective hub shaft is aligned with the plane 74 of the center lines of the drive-unit axles 25a, 26a.

For use with larger vehicles requiring longer tracks, the center portion of each endless track 14, 15 is also preferably in frictional contact with the tires of an “idler” dual-wheel 76 that is positioned between the tandem dual-wheels of the drive units 17a and 18a. The idler dual-wheel 76 is supported on a conventional mounting in the form of a rocker arm 78 that is also biased by a spring force 80 in the direction of the terrain. The spring force 80 is intentionally designed to bias the dual-wheel 76 with greater force than the spring forces biasing the dual-wheels of the drive units 17a and 18a. This increased spring pressure causes the center of each track to carry more of the load when the vehicle is standing or traveling over flat, even surfaces (e.g., pavement), thereby facilitating the turning of the vehicle under these conditions.

In a manner similar to the articulation of the dual-wheels of the drive units 17a and 18a, the idler dual-wheel 76 is also conventionally stopped in the relative position shown in FIG. 1. It is also free to move independently upward in a vertical plane against the downward spring bias to a maximum upward position where its hub-shaft centerline 82 is aligned with the plane 74 of the center lines of the drive-unit axles 25a, 26a.

As can be seen in FIGS. 1 and 2, each endless track 14, 15 includes a line of interior lugs 86 spaced in alignment with the central axis of the track. The lugs 86 are designed to be received between the sidewalls of the tires mounted on the tandem dual-wheels of the drive units 17a, 18a and on the idler dual-wheel 76. The tires are deflated prior to track installation and then inflated to provide a firm frictional connection between the rubber surfaces of the tires and the interior of the tracks. The lugs 86 maintain the tracks 14, 15 in proper covering relationship over the tires.

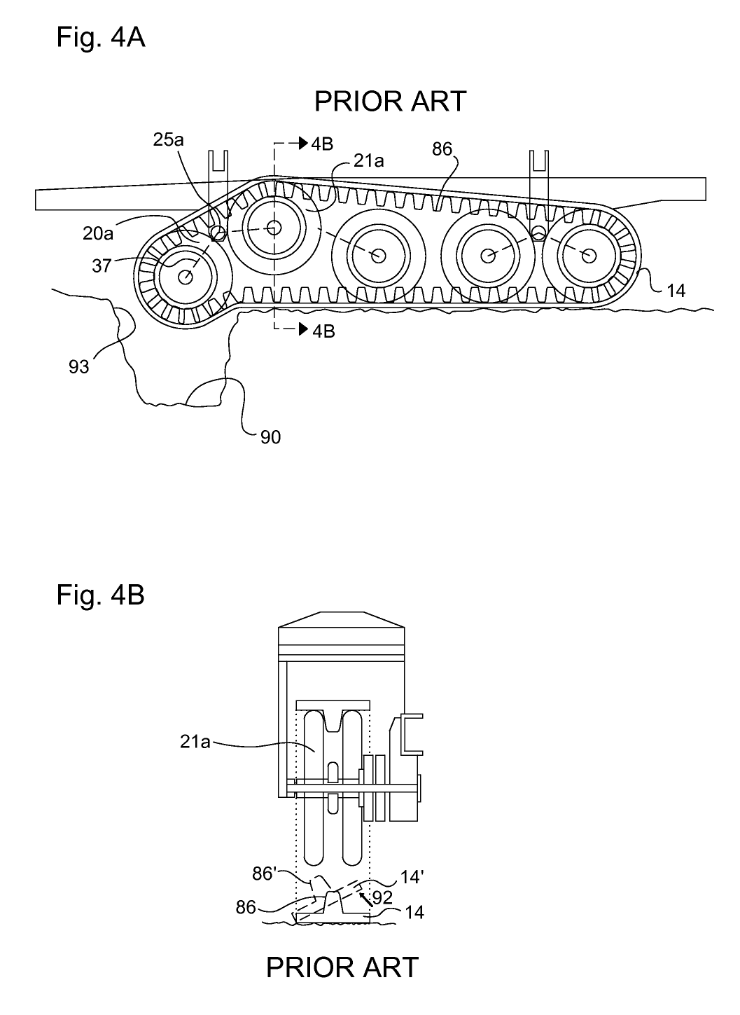

A prior art problem is illustrated schematically in FIGS. 4A and 4B, which show the front end of the prior art track suspension encountering a deep depression 90 in the terrain while the remaining portions of the track 14 are still progressing over a generally higher level of terrain. When the dual-wheel 20a drops into the depression 90, it causes the rocker arm 37 to swing through an unusually long downward arc and, simultaneously, causes the other wheel 21a of the tandem pair to swing through an unusually long upward arc about the shared axle 25a of the tandem pair. Although the resilient springs 68, 69 shown in FIG. 1 bias the tandem pair toward the terrain and operate against conventional mechanical stops, the entire tandem mounting is still free to rotate in a rocker arm manner about the shared axis 25a of the pair. When such extreme variations in terrain occur, the upward-moving dual-wheel 21a may be raised so great a distance above the interior surface of the terrain-contacting portion of track 14 that the guide lugs 86 on the interior surface of the track 14, which are used for retaining alignment of the track with the dual-wheels of the suspension, are completely withdrawn from between the tires of the dual wheel 21a. As shown in FIGS. 4A and 4B, when a portion of the track 14 is momentarily out of contact with the dual-wheel 21a, it is possible that the vehicle may be turning or may strike a terrain obstruction that causes a lateral or angular distortion of the uncovered portion of the track 14 (see directional arrow 92 and the dotted illustration of track 14′ in FIG. 4B). This may occur at or near the same time that the dual-wheel 20a of the tandem pair suddenly strikes rising terrain 93, causing the rocker arm 37 to swing back in an upward arc. This condition causes the dual-wheel 21a of the pair to be driven back downward toward the terrain and back toward the interior of the track 14. If, under these conditions, the guide lugs 86′ of the distorted track 14′ move to the outside of the returning dual-wheel 21a and the track 14 becomes misaligned, the track 14 may become derailed.

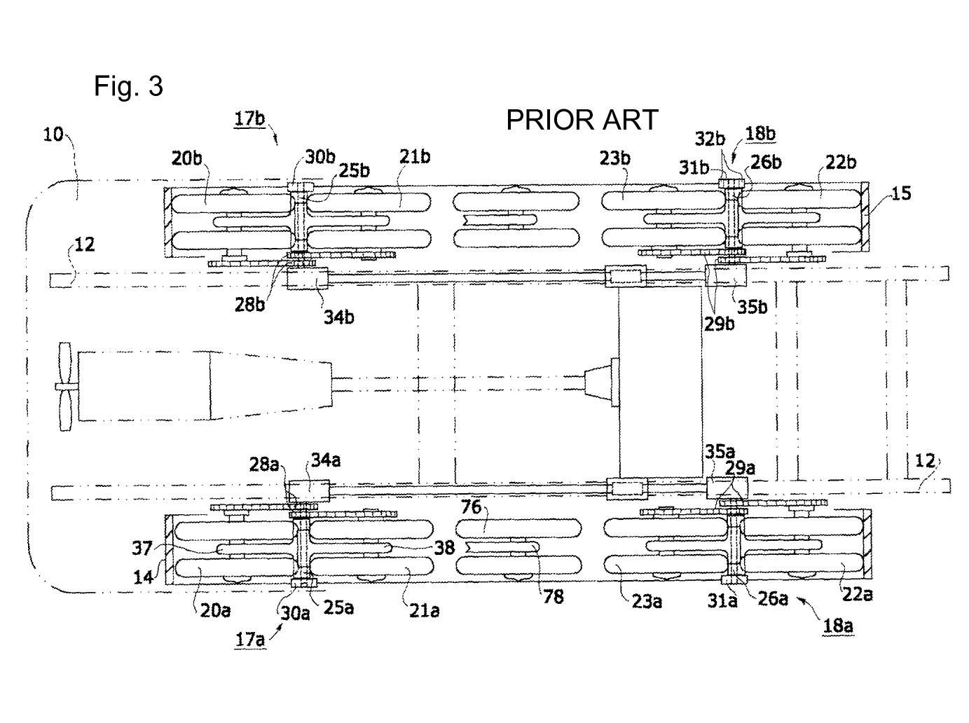

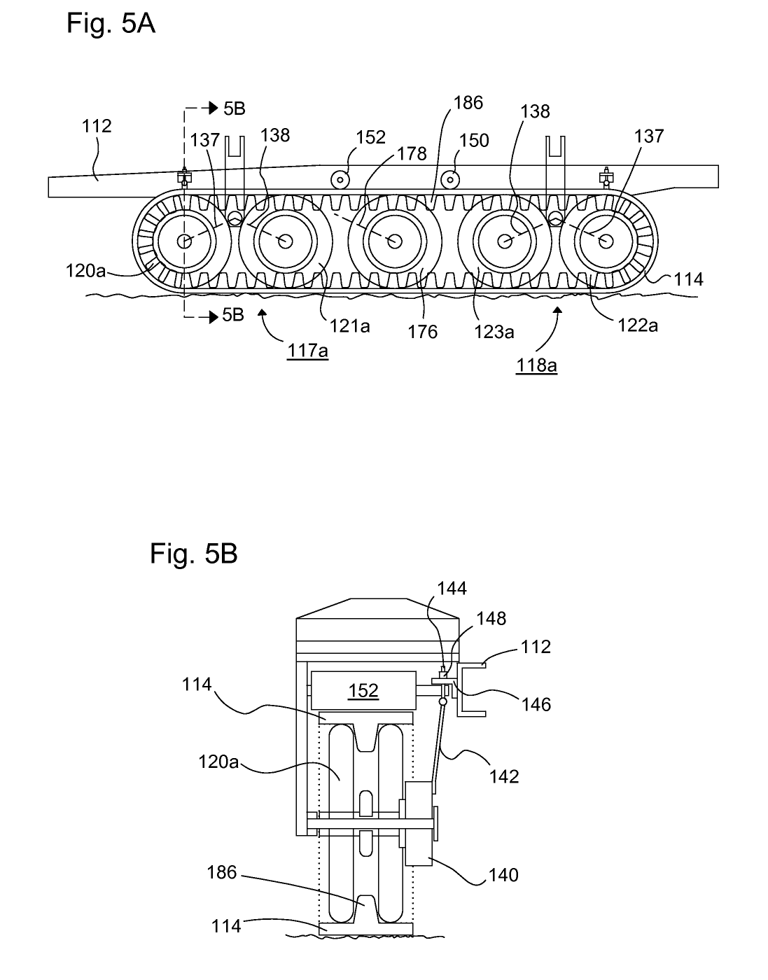

This problem is substantially mitigated by the improvements shown schematically in FIGS. 5A and 5B that illustrate a preferred embodiment of the present invention standing on level ground. A basic frame 112 is suspended by a pair of endless tracks, with only the left track 114 being shown in the figures, the left-side track 114 and right-side track and their supporting drive structures preferably being mirror images of each other. The tracks are supported at each respective end by two respective tandem pairs 117a, 118a, e.g., the dual-wheels 120a, 121a and 122a, 123a, which are mounted to respective rocker arms 137, 138. The endless track 114 is also supported at the center by an undriven idler dual-wheel 176 mounted on a rocker arm 178. These dual wheels are all resiliently spring-biased toward the terrain and driven in the manner explained with reference to FIGS. 1, 2, and 3. The springs 68, 69, and sprockets 28, 29 of FIGS. 1 and 3, have been omitted in FIGS. 5A and 5B for clarity.

The improvements shown in FIGS. 5A and 5B are preferably associated with the outer rocker arms and dual-wheels of the front and rear ends of each of the vehicle's tracks and, since they are all functionally identical, only improvements related to one tandem pair 117a are described in detail.

Each outer dual-wheel 120a is driven by a respective chain and sprocket arrangement carried within a respective structural support casing 140 that is mounted to and moves with respective rocker arm 137. The respective ends of a strap 142 that is preferably flexible but non-resilient are connected to the frame 112 and the casing 140. In the embodiment illustrated, the lower end of the strap 142 is permanently fixed to the casing 140, while the upper end of the strap 142 is adjustably connected to the frame 112 by a bolt-like element 144 threaded into a bracket 146 (welded to frame 112) and secured by a nut 148. The length of the strap 142 is preferably adjusted when the vehicle is standing on a flat surface as shown in FIG. 5A so that when fully extended, the dual-wheel 120a is in snug contact with the terrain.

A suspension of the present invention also preferably includes at least one small top idler roller 150, 152 between the front tandem pair 117a and the rear tandem pair 118a. In the embodiment shown in FIG. 5A, a first top roller 150 is positioned between the front dual-wheel 123a of the rear tandem pair 118a and the idler dual-wheel 176, and a second top roller 152 is positioned between the idler dual-wheel 176 and the rear dual-wheel 121a of the front tandem pair 117a. Each small top roller 150, 152 is preferably respectively mounted on an axle supported by the frame 112 so that, when the vehicle is standing on a flat surface as shown in FIG. 5A, the roller is slightly above the track 114 and preferably extends perpendicularly over the entire width of the outer surface of the track 114 as shown in FIG. 5B.

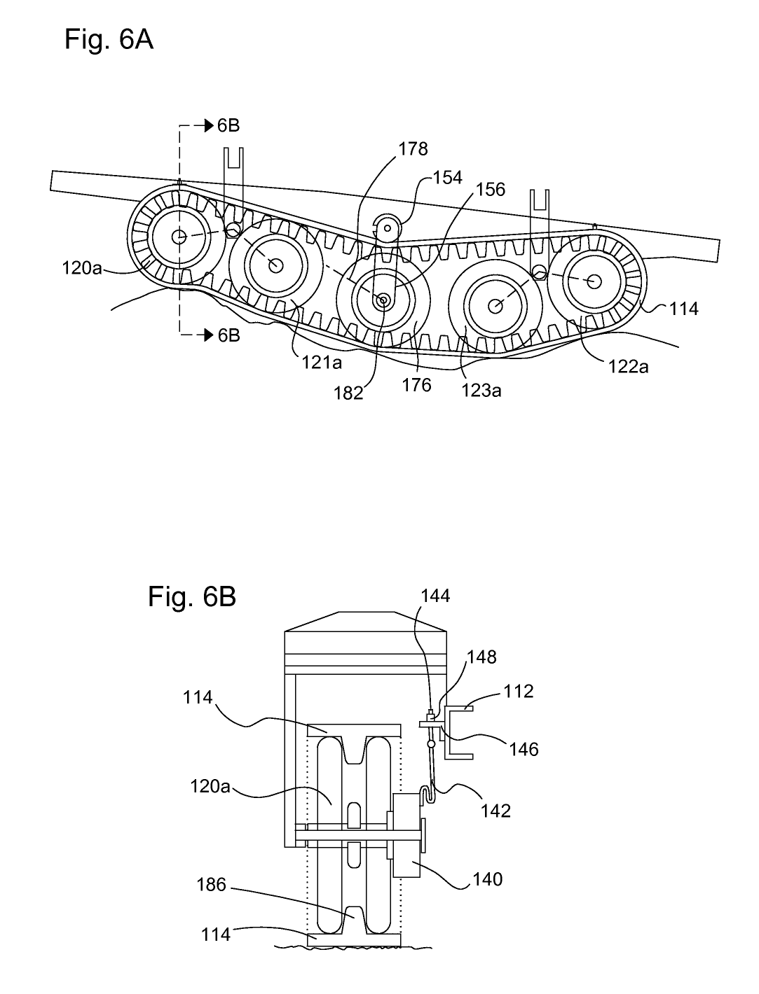

FIGS. 6A and 6B show an alternative embodiment of the present invention where the small top idler rollers 150, 152 have been replaced with a single top idler roller 154 supported in a cantilever strut element 156 that straddles the hub shaft 182 of the idler dual-wheel 176 and the rocker arm 178. The strut element 156 is free to rotate about the axis of the hub shaft 182 through a limited arc to each side of the illustrated vertical position in response to the movement of the rocker arm 178. Similar to the top rollers 150, 152, the cantilever-supported top roller 154 is also preferably positioned so that when the vehicle is standing on a flat surface, the roller 154 is maintained slightly above the track 114 and extends perpendicularly over the entire width of the outer surface of the track 114.

FIGS. 6A and 6B show the improved suspension in an embodiment of the present invention encountering rising terrain. The flexible strap 142 allows the dual-wheel 120a and rocker arm 137 to move in an upward arc to accommodate the rising terrain, and this similar freedom is allowed by the same flexible strap associated with the rear dual-wheel 122a. That is, the inventive strap arrangements of the invention neither restrict nor impair the upward movements of the dual-wheels in contact with the terrain. At the same time, the top roller 154 prevents the guide lugs 186 on the interior of the upper portion of the track 114 from completely withdrawing from between the interior surfaces of the respective dual-wheels (e.g., dual-wheels 121a, 123a).

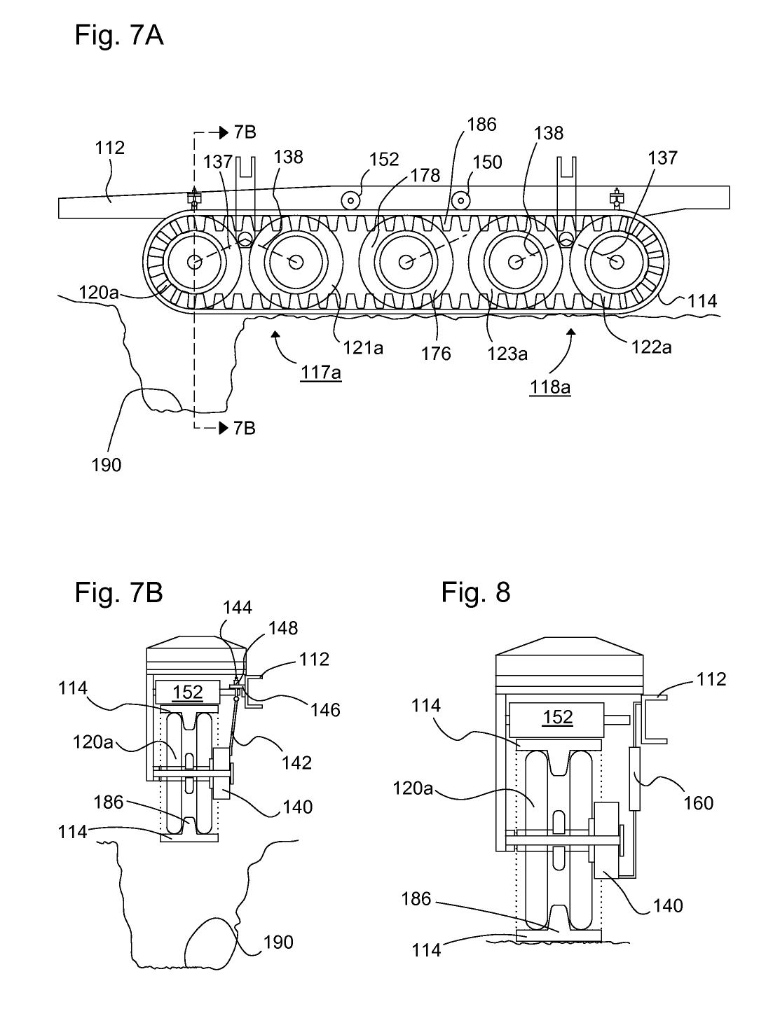

On the other hand, when the front end of the endless track suspension encounters a deep depression 190 in the terrain while the remaining portions of the track 114 are still progressing over a generally higher level of terrain, as shown in FIGS. 7A and 7B, the strap 142 once again effectively minimizes the downward movement of the dual wheel 120a and the rocker arm 137, thereby also minimizing the concomitant undesirable rising of the dual-wheel 121a in response to the otherwise possible rotation of the tandem pair 117. Further, any slight upward movement away from the terrain by the dual-wheel 121a is also resisted by the pressure of the roller 150 on the outer surface of the upper portion of the track 114.

FIG. 8 illustrates another preferred embodiment of the present invention. In this embodiment, a shock-absorbing element 160 is positioned in the vicinity of the strap 142, preferably also being connected between the frame 112 and the same sprocket casing 140 to dampen the movement of the front dual-wheel 120a. The shock-absorbing element 160 only effectively dampens movements in a downward direction. The upward movements of the dual-wheels in response to contact with the terrain remain relatively unrestrained. This shock-absorbing element is preferably used only on the tandem wheel pair used to support the front end of the flexible endless track.

While the above descriptions are directed to an engine-driven track system, it should be understood that the present invention applies equally to any similar track suspensions used to support a non-driven trailer-type vehicle.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A track suspension system for a tracked vehicle, the vehicle comprising a load-bearing frame carrying at least one support axle, and the suspension system comprising at least one endless track with an exterior surface that contacts terrain and an interior surface supported by at least one pair of tandem wheels comprising a forward wheel and a rearward wheel, wherein the forward wheel and the rearward wheel are each independently rotatable about a respective separate axle mounted in a respective movable rocker arm, wherein each movable rocker arm is independently movable in a vertical plane about the axis of the support axle and resiliently biased in the direction of the terrain, wherein the improvement comprises:
at least one strap interconnecting the vehicle frame and one of the movable rocker arms, the strap being positioned so that motion of the rocker arm about the support axle in the direction of the terrain is limited to a predetermined distance, wherein the strap is flexible and non-resilient.

2. The track suspension system of claim 1, wherein the predetermined distance of motion of the rocker arm is adjustable.

3. The track suspension system of claim 2, wherein an end of the strap is adjustably anchored to the vehicle frame.

4. The track suspension system of claim 1 further comprising a shock-absorbing element mounted in proximity to the strap and interconnecting the vehicle frame and one of the movable rocker arms, wherein the shock-absorbing element dampens the movements of the movable rocker arm in the direction of the terrain.

5. The track suspension system of claim 1, wherein the strap is connected to the movable rocker arm of the forward wheel of the tandem pair.

6. The track suspension system of claim 1, wherein the strap is connected to the movable rocker arm of the rearward wheel of the tandem pair.

7. The track suspension system of claim 1, wherein the at least one pair of tandem wheels comprises a first pair of tandem wheels supporting the front end of the endless track and a second pair of tandem wheels supporting the rear end of the endless track, and wherein the at least one strap comprises:
a first strap connected to the movable rocker arm of a forward wheel of the first tandem pair; and
a second strap connected to the movable rocker arm of a rearward wheel of the second tandem pair.

8. The track suspension system of claim 7 further comprising at least one idler roller attached to the frame and positioned to contact the exterior surface of the track at a location between the first tandem pair and the second tandem pair.
